(19) United States
(12) Patent Application Publication
(10) Pub. No.: US 2009/0295587 A1
(43) Pub. Date: Dec. 3, 2009

(54) Severe weather, environmental and mass notification warning system and method

(76) Inventor: Thomas Leo Gorman, JR., Chesterfield, VA (US)

Correspondence Address: MICHAEL RIES, 318 PARKER PLACE, OSWEGO, IL, 60543, US

(21) Appl. No.: 12/395,711

(22) Filed: Mar. 2, 2009

Related U.S. Application Data
(60) Provisional application No. 61/032,973, filed on Mar. 2, 2008.

(51) Int. Cl. G01W 1/00

(52) U.S. Cl. 340/601

(57) ABSTRACT

A severe weather monitoring system including a local event detector wherein the local event detector includes at least one electric field monitor and at least one electromagnetic sensor. A local grid computer receives local data from the electric field monitor and the electromagnetic sensor, the local grid computer is connected to the Internet to periodically send information about local environmental conditions to local and remote communications devices, such as computers and cell phones. The local grid computer includes software to analyze the local data and to post the local data to a computer network and wherein the local grid computer can trigger a local on site alert in event of the sensed data indicating a dangerous condition.

### CROSS REFERENCES TO RELATED APPLICATIONS

This application claims priority under 35 USC 119 to U.S. Provisional Application 61/032,973 filed 2 Mar. 2008, the entire disclosure of which is incorporated by reference.

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates to a system and method of warning people about dangerous conditions

2. Brief Description of Prior Art.

Each year approximately 50 people are killed by lightning strikes in the US alone, and many more are injured. There are about 100,000 severe storms each year in the US and these trigger a variety of dangerous conditions including wild fires. Although sophisticated weather detection early warning systems have been developed these systems tend to cover large areas and provide warnings that apply to large areas and do not relate to lightning. As a result people often ignore the warnings, or think that the immediate danger from a storm is not close. These early warning systems tend to focus on tornadoes, hurricanes, hail and high winds that will cover a large area.

As will be seen from the subsequent description, the preferred embodiments of the present invention overcomes these and other shortcomings of the prior art.

### BRIEF DESCRIPTION OF THE DRAWINGS

FIG. 1 Shows a relational diagram of the system;

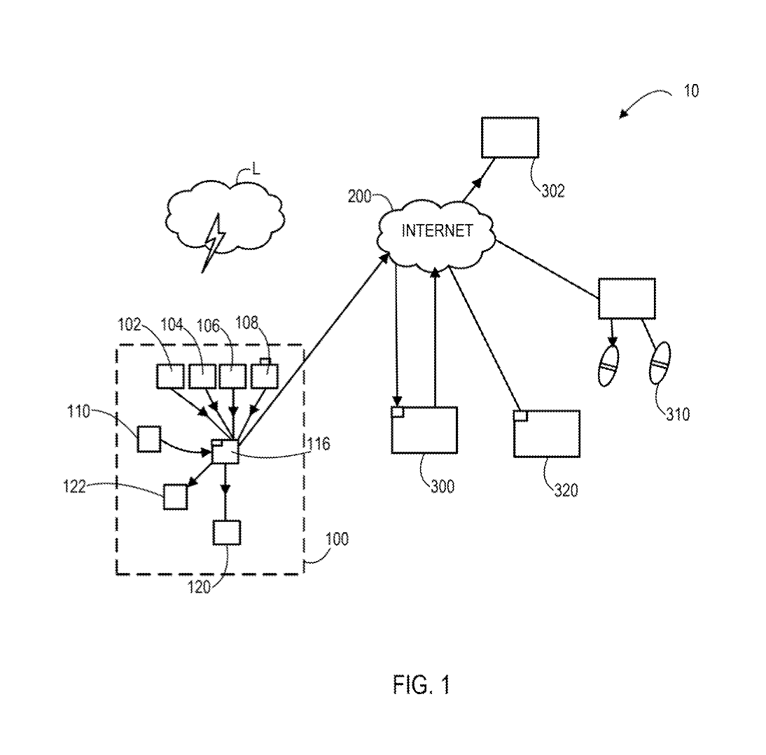

FIG. 2 Shows a screen shot of a computer using the system;

FIG. 3 Shows a flow chart of the system in operation; and

FIG. 4 Shows an alternate embodiment of the system.

### DESCRIPTION OF THE PREFERRED EMBODIMENT

In accordance with the present invention, a network grid event alert system such as a weather alert system and method is disclosed. The network grid alert system 10 includes a plurality of local event detectors 100. A local event detector 100 is shown in dashed lines. The local event detector 100 includes a plurality of diverse local monitors and sensors including at least one electromagnetic lightning detector 102 and at least one electrostatic sensor 104 capable of monitoring atmospheric conditions that occur prior to the arrival of severe weather, build up of electrostatic charge and of detecting local lightning discharges or strikes L. The detector 102 and sensor 104 can be placed on high points around a location to be protected such as a school, airport, hospital, stadium, golf course or industrial plant for example. The local event detector 100 can also include a weather station 106 that might include a plurality of individual instruments such as a barometer, thermometer, anemometer, rain collector, and pyranemometer for measuring solar radiation for example. The local event detector can also have at least one camera or high definition optical monitor 108 capable of observing, recording and time stamping local conditions and events visually. The local event detector 100 can also include data input from remote sources 110 that might include other local event detectors, radar imagery, satellite imagery, and vertical integrated liquid imagery for example. The local event detector 100 can assemble the data from all data sources 102, 104, 106, 108 and 110 in a local storm grid (StormGrid) computer 116 and set off an alert 120 if the data indicates a threatening condition. The alert system 10 uses software and artificial intelligence to determine the potential of and detection of severe weather related concerns and delivers alert notifications (In a system commercially known as Alert119) on-site and off-site through various means of communication. The alert could be automated or set to manual over-ride and take many forms including network and web-enabled warning notices, audible alert tones or sirens, visual alerts, pre-recorded voice messages, text-to-speech, live public addresses, remote control of equipment, and email and text message alerts and automated telephone calls to any PBX, cell phone or VoIP phone for example. The alert may also be used for any general or specific notification or mass notification for any immediate concerns (Alert119).

The local event detector 100 is connected to a local computer network as well as the Internet 200 such that data from the local event detector 100 can be communicated to people in the local area as well as people outside the local area. A weather grid (WeatherGrid) server computer 300 gathers data from a plurality of local event detectors 100 and other sources available through the Internet 200 and assembles and analyzes the data. The weather grid server computer 300 can trigger remote alarms 302 through the Internet 200, these alarms 302 could be in the local area or in the path of a storm or event for example. The grid server computer 300 can send a message such as a pre-recorded text message to a plurality of phones such as cellular phones 310 and can also send alert data to computers 320. The local event detector 100 can remotely control electrical equipment 122, for example the event detector might turn off a computer in response to lightning strikes or might turn on a backup generator for a hospital if conditions were right to lose power for example.

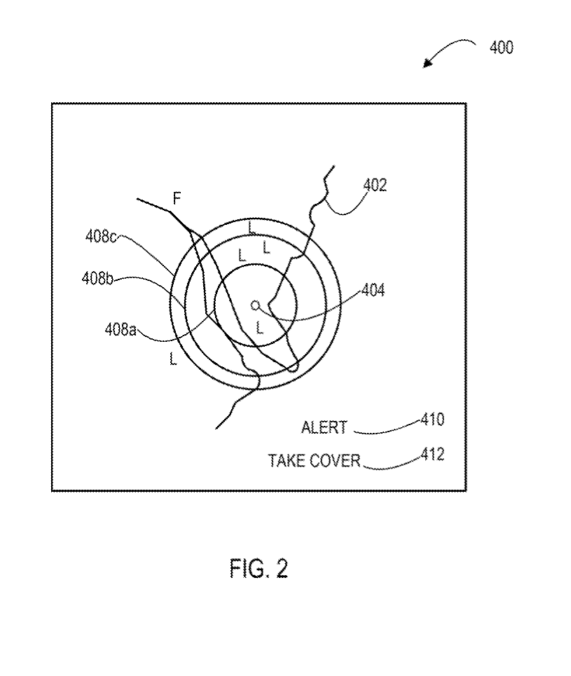

FIG. 2 shows a screen shot 400 that might be displayed on a computer screen, jumbo screen or cell phone screen for example. The screen shot 400 shows an outline of a map 402. The screen shot 400 can have a location center 404 that might be the location of a place such as a golf course, school or stadium for example or the location center 404 might be the GPS location of a user. Concentric rings 408 can be placed on the screen concentric with the location center 404 and these rings 408 will give a visual display of how far away events such as lightning strikes L are occurring from the location center 404. For example each ring might be 10 miles larger in radius than the one just inside. The shapes such as the concentric rings 408 might also indicate severity of conditions within each ring 408. For example, the ring 408a might be red and might indicate that electrical storm activity is extremely high within the ring 408a which would be the area where the user might be. The ring 408a might be yellow and might indicate that electrical storm energy is shifting into the enclosed region. The ring 408a might be white and might indicate that electrostatic energy has been increasing within the region or the ring 408a can be green indicating no immediate lightning threat. Although shown as concentric rings 408a, 408b and 408c it will be understood that these could be any shape and in any location dependent upon the actual data, there could be a number of shapes on the map 402 and they may or may not overlap depending upon actual conditions. The events such as lightning strikes L can be visually coded to tell how long ago they occurred. For example, a lightning strike might by recorded in red when it occurs and then might fade in brightness or change color over time to indicate time passing. So a strike L might start as red and remain red for 1 minute, then change to yellow for 2-5 minutes then go to white for 5-8 minutes and then black for 8-10 minutes and finally disappear. The strike L might also change from a bright indicator to a dim indicator over time for example. This gives a viewer of the screen 400 a snap shot of data of what is happening over a short period of time in a very local area. FIG. 2 also shows that there can be indicia on the screen 400 such as an alert 410 and instructions 412 for example. The screen shot 400 shows a small area map 402, it will be understood that the user could zoom in or out to make the screen shot 400 show a larger or smaller area. The system 10 can show an area up to 200 miles in radius and the system has a 360 degree view and yet still shows and focuses on the risk at the exact GPS location of respective users. The combination gives a user the ability to track a storm from 200 miles away but from their exact location. Other environmental events could be shown on the map 402 and screen shot 400 for example local flooding or risk of flooding might be indicated with a flashing F.

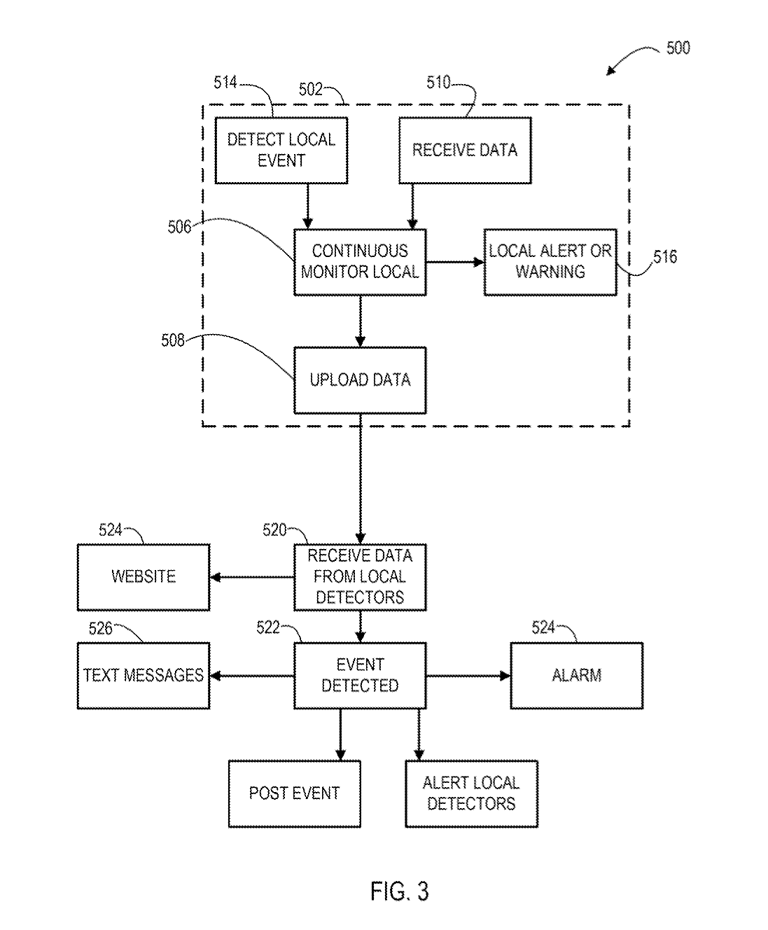

FIG. 3 shows a typical flow chart 500 of the operation sequence of the alert system 10. The flow chart 500 includes a sequence 502 for the local detectors 100. The local detector 100 is constantly monitoring 506 for a local event and uploading current conditions 508 to grid server computer 300. The detector 100 continuously receives 510 data from local sensors and monitors 102, 104, 106 and 108 as well as data from other remote sources 110. When an event is detected 514 a local alert or warning can be triggered 516. There can be a threshold value that would trigger a warning and a higher threshold value than would trigger an alert. For example, a single lightning strike L may trigger a warning but not and alert. Multiple lightning strikes L in a short period of time would trigger an alert. A warning would also be triggered if conditions were right for severe weather such as a build up of electrostatic energy. The grid server computer 300 receives data 520 from a plurality of the local detectors 100 as well as other data through the Internet 200 or other sources. The data from these local detectors can help track small cells within a larger storm for example and provide a warning to local detectors in the path of a storm cell. The grid server 300 can maintain a web site on the Internet 200 that is accessible via computers 320 at any time to monitor local conditions. If an event is detected 522 at any one or several local detectors 100 a warning or alarm 524 can be issued to any affected location. A message can be sent via text messaging 526 to cell phones 310 subscribing to receive a message concerning the event. A web site can be maintained and periodically or continuously updated with data and that would contain the data displayed on the example screen shot 400. The event detection 522 can include calculating a risk of a severe event based on uploaded data 508 from a plurality of local event detectors 100 in the network grid system 10.

Each local detector 100 could have a different array of sensors and yet could work together on the grid system network. For example, one county in a state may only be able to afford an electric field monitor 102 whereas another county may have a full range of sensors 102, 104, 106 and 108. Another county close to a river might modify a local event detector to include a flood warning not available in other areas. This allows local areas and even individual customers to customize the local detector 100 but to monitor the information they feel is important from the entire network system 10. User configurable alarms can be set for temperature, heat index, wind chill, wind speed, and rainfall within specific time frame parameters. The Networking System 10 consists of a single Web Server 300 with three or more external node local detectors 100 connected via the Internet 200. Each local detector is a customized Weather Mapping Module at a specific location. Clients with real-time safety concerns will choose to have a local detector on-site which contributes data to the Network system 10. Subscribers will have access to the weather information by logging into the Network system Web Server 300 using their favorite browser.

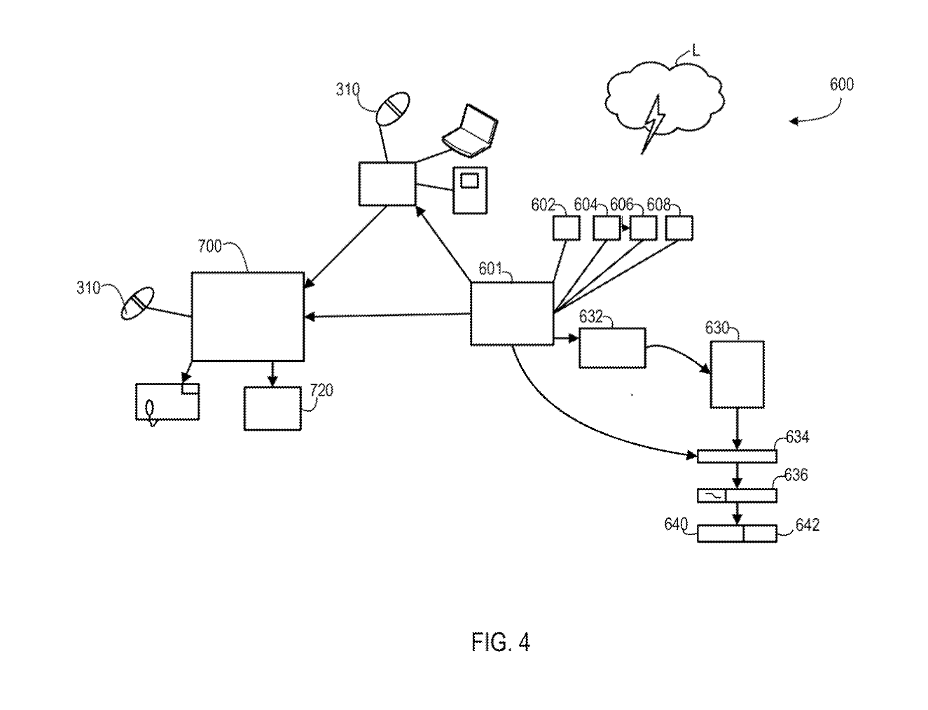

FIG. 4 shows an alternate embodiment of the system 600. A local event detector 601 includes a computer having a static IP address. The local event detector 601 includes a plurality of diverse local monitors and sensors including at least one electromagnetic lightning detector 602 and at least one electrostatic sensor 604 capable of monitoring atmospheric conditions that occur prior to the arrival of severe weather, build up of electrostatic charge and of detecting local lightning discharges or strikes L. The local event detector 602 can also include a weather station 406 that might include a plurality of individual instruments such as a barometer, thermometer, anemometer, rain collector, and pyranemometer for measuring solar radiation for example. The local event detector can also have at least one camera or high definition optical monitor 608 capable of observing, recording and time stamping local conditions and events visually. The local event detector 601 can also include data input from remote sources that might include other local event detectors, radar imagery, satellite imagery, and vertical integrated liquid imagery for example. The local event detector 601 can send signals to a remote monitoring station 620 that can send signals to a cell phone 622, a lap top computer 624 and a PDA 626 for example and can assemble the data from all data sources 602, 604, 606, 608 in a local storm grid (StormGrid) computer 601 and set off a mass notification alert if the data indicates a threatening condition. The alert system 600 uses software and artificial intelligence to determine the potential of and detection of severe weather related concerns and delivers alert notifications (In a system commercially known as Alert119) on-site and off-site through various means of communication. The alert could be automated or set to manual over-ride and take many forms including network and web-enabled warning notices, audible alert tones or sirens, visual alerts, pre-recorded voice messages, text-to-speech, live public addresses, remote control of equipment, and email and text message alerts and automated telephone calls to any PBX, cell phone or VoIP phone for example. The alert may also be used for and general or specific notification or mass notification for any immediate concerns (Alert119).

The local event detector 601 is connected to a local computer network 630 through a router 632. The local computer network 630 can set off a visual 640 and audible 642 alarm through a switch 634 and smart relay 636. It will be understood that there cold be plural alarms 640, 642 as required. The local event detector 601 is connected to the Internet 200 such that data from the local event detector 601 can be communicated to people in the local area as well as people outside the local area. A weather grid (WeatherGrid) server computer 700 gathers data from a plurality of local event detectors 601 and other sources available through the Internet 200 and assembles and analyzes the data. The weather grid server computer 700 can trigger remote alarms through the Internet 200, these alarms could be in the local area or in the path of a storm or event for example. The grid server computer 700 can send a message such as a pre-recorded text to speech messages to a plurality of phones 702 such as cellular phones 310 and can also send alert data such as email and web alert notifications to computers 720. The local event detector 601 can remotely control electrical equipment.

In use an example would be a local golf course could install detectors 102 and 104 to monitor for lightning in a local area and to predict lightning strikes before they happen. A threshold can be set at the local detector 100 and local storm grid computer 116 would sound an alarm 120 in the form of a siren or public address to clear the golf course if more than a threshold number of lightning strikes occur within a 5 mile radius of the golf course within a given period of time. Data from this local storm grid computer would be uploaded to the Internet 200. At the same time a school 10 miles from the golf course might receive a warning on an office computer 320 that lightning strikes have been detected in a storm cell that is moving toward the school. The system 10 has the ability to respond to an electrical storm by turning off sensitive electrical equipment such as computers 320 or by turning on back up generators as it disconnects a school or hospital from the electrical grid. The system 10 is also capable of delivering notification to parent's cell phones 310 and computers 320 in event of a school lock down or closing due to weather or other dangerous conditions. The network grid system 10 provides local detection combined with regional monitoring of weather conditions.

In one embodiment of the invention, the invention provides a severe weather monitoring and alert system, network grid system, or computer implemented methods that including a local event detector system, wherein the local event detector and alert system comprises:

(a) at least one electrostatic sensor;

(b) at least one electromagnetic lightning detector; and

(c) a local grid computer comprising computer implemented communications methods for receiving local data from said electrostatic sensor and said electromagnetic lightning detector,

wherein,

(i) at least one local grid computer with access to the local data from the sensor and detector is connected to the Internet and comprises software implemented methods to periodically send information about local environmental conditions as data to local and remote communications devices;

(ii) at least one local grid computer comprises software implemented methods to analyze data prior to sending the data to the computer network comprising local and remote communications devices, and

(ii) at least one local grid computer comprises software implemented methods to trigger a local on-site or remote alert in the event that analysis of data detects a dangerous local condition.

In a further embodiment, the severe weather monitoring and alert system, network grid system, or computer implemented methods as described above may utilize local data that includes information about one or more of: (i) the potential of a lightning strike in a location, and (ii) information about the location and frequency of lightning strikes,

wherein

software implemented logic and data can analyze the location and frequency of lightning strikes and trigger an alert, and

the alert triggered can trigger actions to remotely control electrical equipment that is located in an alert zone.

In a further embodiment, the severe weather monitoring and alert system, network grid system, or computer implemented methods described above utilize local data that may be accessed by the system for analysis, which includes information about one or more of: (i) the potential of a lightning strike in a location, and (ii) information about the location and frequency of lightning strikes, and

wherein

software implemented logic and data can analyze the location and frequency of lightning strikes and trigger an alert, and

the alert triggered comprises an alert notification by one or more of a visual display, a siren, a pre-recorded message and a text message.

Preferably, the severe weather monitoring and alert system described above utilizes a local event detector that further comprises a local weather station comprising one or more devices selected from a thermometer, barometer, an anemometer, rain fall gauge, and solar radiation detector and data from local weather detection data is provided to the system for combining with other local data for analysis to determine whether to trigger an alert.

One embodiment of the severe weather monitoring and alert system, network grid system, or computer implemented methods described above utilize a system that receives and analyzes the combination of local data from at least one local event detector and remote data from at least one other remote event detector selected from radar and satellite imagery and includes logic to combine remote data with local data to determine whether to trigger an alert. The communications devices may comprise one or more of the Internet, telephones, cell phones, communication enabled sirens, remote control devices, and computers.

The severe weather monitoring and alert system, network grid system, or computer implemented methods described above utilize communications devices that comprise a website on the Internet and the website provides a map that can display local lightning strike locations occurring within a period of time, and wherein said lightning strikes are maintained on the map for a period of time such that frequency and location of lightning strikes in an area might be visually displayed.

The severe weather monitoring and alert system, network grid system, or computer implemented methods described above are those wherein said local event detector is part of a network grid system having a plurality of local event detectors and can be configured by the end user to detect data and report events not used by the network alert system logic in determining whether to trigger an alert.

In a further aspect, the invention provides a computer and communications implemented method of monitoring weather and providing local or remote alerts comprising:

(a) sensing electrostatic energy in at least one geographic area;

(b) sensing electromagnetic energy in at least one geographic area;

(d) sensing lightning strikes in at least one geographic area;

(e) detecting or receiving by communication additional weather related data from at least one local weather station,

(f) recording lightning strike location and frequency with indicia and maintaining said indicia for a period of time;

(g) utilizing data from one or more of (a)-(f) and computer implemented logic operating on a local grid computer, or networked remote computer, to calculate a risk of eminent additional lightning strike events in at least one particular geographic area; and

(h) triggering an alert in a local geographic area and responding to the alert, wherein the process of triggering an alert and responding to an alert includes the steps of sending at least one message to at least one communications device in the geographic area, remotely turning off at least one piece of electrical equipment, and remotely turning on at least one back up generator in the geographical area.

Particularly preferred is such a computer and communications implemented method of monitoring weather and providing local or remote alerts wherein the step of detecting or receiving by communication additional weather related data comprises data from at least one of temperature, wind speed, precipitation, barometric pressure, solar radiation, and dew point. Providing local or remote alerts may involve the step of recording lightning strike location and frequency with indicia and maintaining said indicia for a period of time further comprises posting a lightning strike as a first color or shape indicia upon a local area alert map located on a web page, or other downloadable document for a first period of time, and then changing the indicia to a second color or shape and maintaining it on the web page or other downloadable document for a second period of time. The method may further comprise the step of sending local data from a first local computer located on a local grid computer to a communications network computer that is in communication with a plurality of local grid computers.

Although the description above contains many specificities, these should not be construed as limiting the scope of the invention but as merely providing illustrations of some of the presently preferred embodiments of this invention. It will be obvious to those skilled in the art that modifications may be made to the embodiments described above without departing from the scope of the invention. Thus the scope of the invention should be determined by the appended claims in the formal application and their legal equivalents, rather than by the examples given.

I claim:

1. A severe weather monitoring and alert system including a local event detector system, wherein the local event detector and alert system comprises:
(a) at least one electrostatic sensor;
(b) at least one electromagnetic lightning detector; and
(c) a local grid computer comprising computer implemented communications methods for receiving local data from said electrostatic sensor and said electromagnetic lightning detector,
wherein,
(i) at least one local grid computer with access to the local data from the sensor and detector is connected to the Internet and comprises software implemented methods to periodically send information about local environmental conditions as data to local and remote communications devices;
(ii) at least one local grid computer comprises software implemented methods to analyze data prior to sending the data to the computer network comprising local and remote communications devices, and
(ii) at least one local grid computer comprises software implemented methods to trigger a local on-site or remote alert in the event that analysis of data detects a dangerous local condition.

2. The severe weather monitoring and alert system of claim 1, wherein the local data includes information about one or more of: (i) the potential of a lightning strike in a location, and (ii) information about the location and frequency of lightning strikes,
wherein
software implemented logic and data can analyze the location and frequency of lightning strikes and trigger an alert, and
the alert triggered can trigger actions to remotely control electrical equipment that is located in an alert zone.

3. The severe weather monitoring and alert system of claim 1, wherein local data accessed by the system for analysis includes information about one or more of: (i) the potential of a lightning strike in a location, and (ii) information about the location and frequency of lightning strikes, and
wherein
software implemented logic and data can analyze the location and frequency of lightning strikes and trigger an alert, and
the alert triggered comprises an alert notification by one or more of a visual display, a siren, a pre-recorded message and a text message.

4. The severe weather monitoring and alert system of claim 1, wherein the local event detector further comprises a local weather station comprising one or more devices selected from a thermometer, barometer, an anemometer, rain fall gauge, and solar radiation detector and data from local weather detection data is provided to the system for combining with other local data for analysis to determine whether to trigger an alert.

5. The severe weather monitoring and alert system of claim 1, wherein the system receives and analyzes the combination of local data from at least one local event detector and remote data from at least one other remote event detector selected from radar and satellite imagery and includes logic to combine remote data with local data to determine whether to trigger an alert.

6. The severe weather monitoring and alert system of claim 1, wherein communications devices comprise Internet, any telephone, cell phones and computers.

7. The severe weather monitoring and alert system of claim 1, wherein communications devices comprise a website on the Internet and the website provides a map that can display local lightning strike locations occurring within a period of time, and wherein said lightning strikes are maintained on the map for a period of time such that frequency and location of lightning strikes in an area might be visually displayed.

8. The severe weather monitoring and alert system of claim 1, wherein said local event detector is part of a network grid system having a plurality of local event detectors and can be configured by the end user to detect data and report events not used by the network alert system logic in determining whether to trigger an alert.

9. A severe weather monitoring and alert network grid system including a plurality of local event detectors and alert systems, wherein each local event detector and alert system comprises:
(a) at least one electrostatic sensor;
(b) at least one electromagnetic lightning detector; and
(c) a local grid computer comprising computer implemented communications methods for receiving local data from said electrostatic sensor and said electromagnetic lightning detector,
wherein,
(i) at least one local grid computer with access to the local data from the sensor and detector is connected to the Internet and comprises software implemented methods to periodically send information about local environmental conditions as data to local and remote communications devices;
(ii) at least one local grid computer comprises software implemented methods to analyze data prior to sending the data to the computer network comprising local and remote communications devices, and
(ii) at least one local grid computer comprises software implemented methods to trigger a local on-site or remote alert in the event that analysis of data detects a dangerous local condition.

10. The severe weather monitoring and alert network grid system of claim 9, wherein the local data includes information about one or more of: (i) the potential of a lightning strike in a location, and (ii) information about the location and frequency of lightning strikes,
wherein
software implemented logic and data can analyze the location and frequency of lightning strikes and trigger an alert, and
the alert triggered provides logic with software or hardware implemented methods to remotely turn off electrical equipment and turn on backup generators in an alert zone.

11. The severe weather monitoring and alert network grid system of claim 10, wherein the alert triggered comprises an alert notification by one or more of a visual display, a siren, a pre-recorded voice message, an email message, a message on voice mail, and a text message communication.

12. The severe weather monitoring and alert network grid system of claim 11, wherein the local event detector further comprises a local weather station comprising one or more devices selected from a thermometer, barometer, an anemometer, rain fall gauge, and solar radiation detector and data from local weather detection data is provided to the system for combining with other local data for analysis to determine whether to trigger an alert.

13. The severe weather monitoring and alert network grid system of claim 11, wherein the system receives and analyzes the combination of local data from at least one local event detector and remote data from at least one other remote event detector selected from radar and satellite imagery and includes logic to combine remote data with local data to determine whether to trigger an alert.

14. The severe weather monitoring and alert network grid system of claim 13, wherein communications devices comprise one or more of a website on the internet, a telephone, a cell phone, a computer, and a plurality that is a combination of two or more or the same or different devices.

15. The severe weather monitoring and alert network grid system of claim 14, wherein communications devices comprise a website on the Internet and the website provides a map that can display local lightning strike locations occurring within a period of time, and wherein said lightning strikes are maintained on the map for a period of time such that frequency and location of lightning strikes in an area might be visually displayed.

16. The severe weather monitoring and alert network grid system of claim 14, wherein one or more local event detector can be configured by the end user to detect data and report events not used by the network alert system logic in determining whether or not to trigger an alert.

17. A computer and communications implemented method of monitoring weather and providing local or remote alerts comprising:
(a) sensing electrostatic energy in at least one geographic area;
(b) sensing electromagnetic energy in at least one geographic area;
(d) sensing lightning strikes in at least one geographic area;
(e) detecting or receiving by communication additional weather related data from at least one local weather station,
(f) recording lightning strike location and frequency with indicia and maintaining said indicia for a period of time;
(g) utilizing data from one or more of (a)-(f) and computer implemented logic operating on a local grid computer, or networked remote computer, to calculate a risk of eminent additional lightning strike events in at least one particular geographic area; and
(h) triggering an alert in a local geographic area and responding to the alert, wherein the process of triggering an alert and responding to an alert includes the steps of sending at least one message to at least one communications device in the geographic area, remotely turning off at least one piece of electrical equipment, and remotely turning on at least one back up generator in the geographical area.

18. The computer and communications implemented method of monitoring weather and providing local or remote alerts according to claim 17, wherein the step of detecting or receiving by communication additional weather related data comprises data from at least one of temperature, wind speed, precipitation, barometric pressure, solar radiation, and dew point.

19. The computer and communications implemented method of monitoring weather and providing local or remote alerts according to claim 17, wherein the step of recording lightning strike location and frequency with indicia and maintaining said indicia for a period of time further comprises posting a lightning strike as a first color or shape indicia upon a local area alert map located on a web page, or other downloadable document for a first period of time, and then changing the indicia to a second color or shape and maintaining it on the web page or other downloadable document for a second period of time.

20. The computer and communications implemented method of monitoring weather and providing local or remote alerts according to claim 17, wherein the method further comprises the step of sending local data from a first local computer located on a local grid computer to a communications network computer that is in communication with a plurality of local grid computers.
